(19) United States
(12) Patent Application Publication
(10) Pub. No.: US 2011/0273394 A1
(43) Pub. Date: Nov. 10, 2011

(54) METHODS AND APPARATUS FOR A TRANSPARENT AND FLEXIBLE FORCE-SENSITIVE TOUCH PANEL

(75) Inventors: Steven Young, Gilbert, AZ (US); Hao Li, Chandler, AZ (US); Yi Wei, Chandler, AZ (US)

(73) Assignee: SYMBOL TECHNOLOGIES, INC., Holtsville, NY (US)

(21) Appl. No.: 12/776,627

(22) Filed: May 10, 2010

(51) Int. Cl. G06F 3/045; B05D 5/12

(52) U.S. Cl. 345/174; 427/58; 427/126.3

(57) ABSTRACT

Methods and apparatus are provided for a transparent and flexible pressure-sensing touch panel. The touch panel includes a flexible and substantially transparent composite layer (e.g., a plurality of conductive particles within a polymeric matrix) such that the resistivity of the composite layer is a function of applied force, and such that the touch panel may be manipulated to conform to a non-planar surface, such as a non-planar display screen.

### TECHNICAL FIELD

Embodiments of the subject matter described herein relate generally to touch panel components and, more particularly, to force-sensitive touch panel displays.

### BACKGROUND

Touch panel displays and other forms of touch panel components have become increasingly popular in recent years, particularly in the context of mobile devices such as smartphones, personal data assistants (PDAs), tablet devices, and the like. Such touch screens typically include a transparent touch panel adjacent to a display, thereby presenting information to the user while at the same time accepting input from the user.

Conventional touch-sensing technologies are capable of sensing the position of one or more touch events occurring on a screen. While some are capable of determining, to some extent, the magnitude of the force or pressure associated with a touch event, the resulting pressure information is generally estimated based on the area of contact, rather than a more direct force measurement.

Furthermore, while transparent touch panels are known, such panels are generally planar or formed rigidly such to conform to the surface of a particular structure, rather than being flexible and able to conform to an arbitrary curved surface.

Accordingly, it is desirable to provide flexible and transparent force-sensitive touch panel displays for use with curvilinear and otherwise non-planar surfaces. Other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is an isometric overview of a touch panel in accordance with one embodiment;

FIG. 2 is an isometric overview of a touch panel according to FIG. 1 manipulated to conform to a curvilinear surface;

FIG. 3 is an exploded perspective view of a touch panel in accordance with FIG. 1;

FIGS. 4 and 5 are conceptual cross-sectional diagrams illustrating the behavior of an exemplary force-sensitive layer; and

FIG. 6 depicts a block diagram of an exemplary touch panel system in accordance with one embodiment.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to touch screen displays, resistive touch panels, polymers, user interfaces, and the like, need not, and are not, described in detail herein.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to systems utilizing pressure-sensing (or force-sensing) touch screens, that is, touch screens capable of measuring or otherwise resolving the force applied to one or more individual locations on the touch screen. In an exemplary embodiment, the touch screen comprises a transparent flexible touch panel that is responsive to force applied to the touch panel by one or more manipulators, such as, for example, a stylus, a pointer, a pen, a finger, a fingernail, or the like.

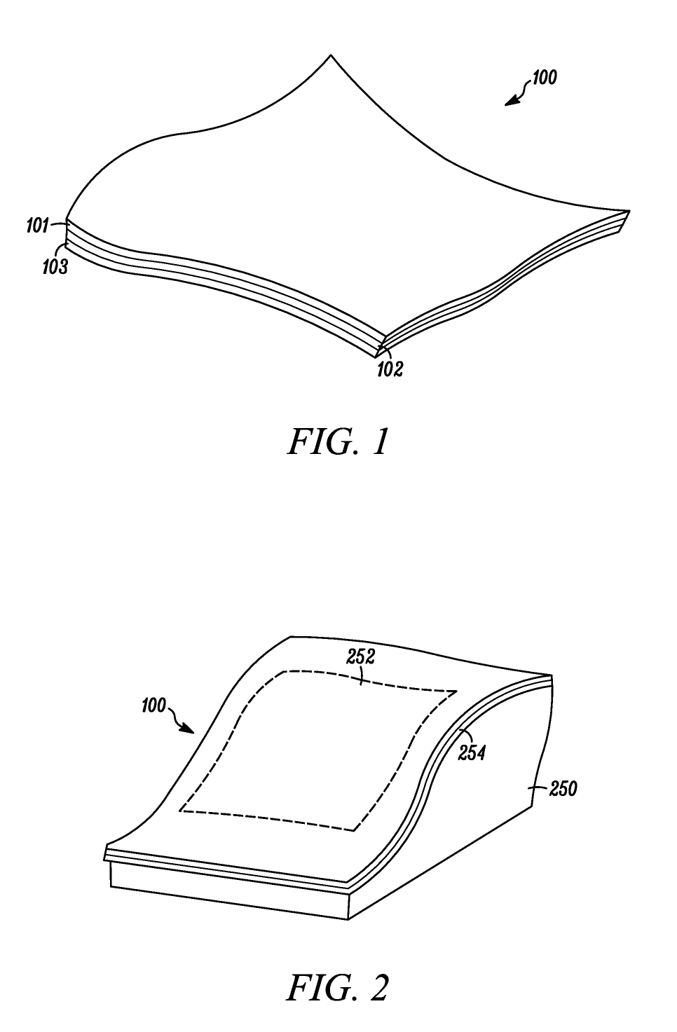

Referring now to FIGS. 1 and 2, the present subject matter generally relates to a flexible, transparent, and force-sensitive touch panel structure (or simply “pane”) 100 which, in the illustrated embodiment, includes a force-sensitive layer 102 situated between a pair of transparent protective layers 101 and 103. As depicted in FIG. 2, due to its flexibility, touch panel 100 may be attached to or otherwise disposed upon a surface 254 of a substrate or other structure 250 (e.g., a display device or the like) that is curvilinear or has any other arbitrary form or topography. In various embodiments, for example, structure 250 may be a wearable component (e.g., a watch, bracelet, etc.), a digital clock face, a digital photo frame, or any other such non-planar structure where incorporation of a touch panel may be advantageous.

Panel 100 is “flexible” (or “resilient”) in the sense that it is not a rigid, substantially planar (or otherwise shaped) structure. That is, panel 100 may be deformed elastically (as illustrated) while still retaining its basic electronic and structural functionality. In one embodiment, for example, panel 100 may be deformed along a single axis (e.g., as though it were wrapped at least partially around a cylinder). In another embodiment, panel 100 may be deformed such that it forms any desired two dimensional manifold shape (spheroidal, polyhedral, etc.). In various embodiments, panel 100 is sufficiently flexible to conform to the underlying structure, if any, to which it is being attached. For example, a panel 100 may be configured to flex such that it can maintain a experience a radius of curvature of about 1.0-2.0 cm while maintaining its functionality.

Panel 100 is “transparent” in that it allows a substantial amount of visible light to be transmitted therethrough. Thus, the term “transparent” as used herein is not limited to strictly “clear” panels, but also includes panels in which a portion of the light is scattered or otherwise blocked to some extent—e.g., a panel that exhibits some amount of haze, or which imparts a particular color to the light transmitted therethrough. In various embodiments, panel 100 is sufficiently transparent (e.g., 90% transparent) that it allows any underlying graphics (e.g., graphics produced by a display 252 incorporated into structure 250) to be seen by a human user.

Panel 100 is “force-sensitive” in that it includes one or more layers of suitable types that, in combination, are capable of producing force information in response to a force or pressure contacting its surface, as described in further detail below. In this regard, while those skilled in the art will recognize that pressure corresponds to force per unit area, the terms “pressure” and “force” may be used to some extent interchangeably herein.

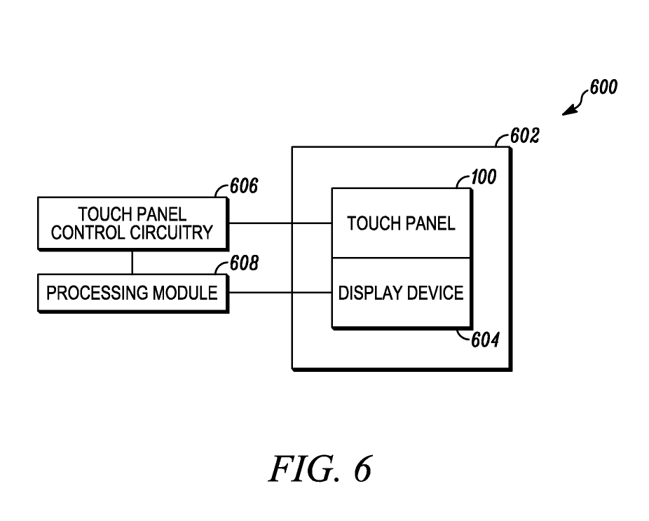

Panel 100 may be used in connection with a wide range of electronic devices. Referring to FIG. 6, for example, an exemplary display system 600 is illustrated. Display system 600 is suitable for use in a computer, a mobile device (e.g., cellular phone, personal digital assistant, or the like), or any another device of the type that might include a touchscreen display. In an exemplary embodiment, display system 600 includes, without limitation, a touch screen 602, touch panel control circuitry 606, and a processing module 608. It should be understood that FIG. 6 is a simplified representation of a display system 600 presented for purposes of explanation and is not intended to limit the scope of the subject matter in any way.

In an exemplary embodiment, touch screen 602 comprises touch panel 100 and a display device 604. Touch panel 100 is coupled to touch panel control circuitry 606, which, in turn, is coupled to the processing module 608. Processing module 608 is coupled to the display device 604, and processing module 608 is configured to control the display and/or rendering of content on display device 604 and correlates information received from the touch panel control circuitry 606 with the content displayed on the display device 604.

Touch panel 100 is pressure-sensitive (or force-sensitive) in that it may be utilized to determine the magnitude of force applied to the touch panel 100 at locations subject to an input gesture on touch screen 602, and subsequently resolve the pressure to the respective impression locations on touch panel 100, as described in greater detail below. Touch panel 100 is preferably disposed proximate display device 604 and aligned with respect to display device 604 such that touch panel 100 is interposed in the line-of-sight between a user and the display device 604 when the user views content displayed on touch screen 602 and/or display device 604. In this regard, from the perspective of a user and/or viewer of touch screen 602 and/or display device 604, at least a portion of touch panel 100 overlaps and/or overlies content displayed on display device 604. In accordance with various embodiments, touch panel 100 is transparent, flexible, and disposed adjacent to a surface of display device 604, which may be curvilinear, non-planar, or have any other arbitrary surface topography.

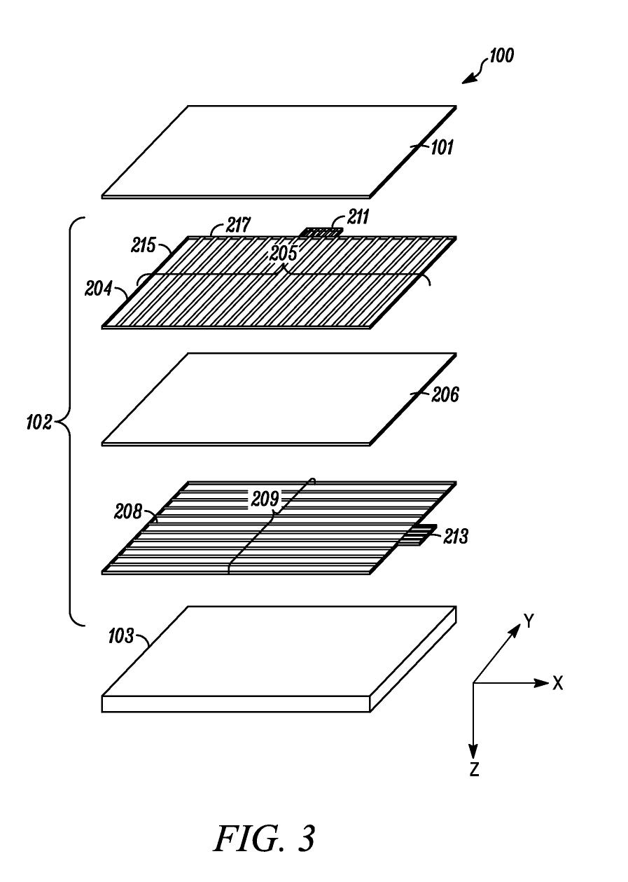

FIG. 3 depicts an exploded view of a transparent flexible touch panel 100 suitable for use as the touch panel 100 in the touch screen 602 of FIG. 6. In the illustrated embodiment, touch panel 100 includes, without limitation, a transparent protective layer 101, a transparent electrode layer 204, a transparent composite layer 206, a transparent electrode layer 208, and a transparent protective layer 103. That is, in the illustrated embodiment, force-sensitive layer 102 of FIG. 1 comprises, collectively, layers 204, 206, and 208.

The transparent protective layers 101 and 103 each comprise a transparent protective material, such as a polymeric material layer, which is disposed on a surface of electrode layer 204. Layers 101 and 103 may comprise, for example, a transparent flexible polymeric material such as polyethylene terephthalate (PET), polymethylmethacrylate (PMMA), polycarbonate (PC), or the like. The thickness of these layers may vary depending upon the desired flexibility and other design factors. In one embodiment, layers 101 and 103 are each have a thickness of about 0.005-0.020 inches (e.g., about 0.010 inches).

In an exemplary embodiment, each of the transparent electrode layers 204 and 208 is realized as a patterned layer having a plurality of transparent conductive traces 205 and 209, with each conductive trace being electrically coupled to a tab or other such structure 211 and 213 for providing an electrical connection to external circuitry (not illustrated). In this regard, in accordance with one embodiment, structures 211 are 213 are coupled to the touch panel control circuitry 606 of FIG. 6. In an exemplary embodiment, transparent conductive traces 205 and 209 are implemented as a transparent conductive oxide such as indium tin oxide, zinc oxide, or tin oxide. Note that, while the illustrated embodiment depicts transparent electrode layers 204 and 208 as a plurality of conductive traces, the present invention is not so limited. Electrode layers 204 and 208 may be implemented, for example, as single blanket-coated transparent electrodes, or any other set of structures capable of resolving a two-dimensional position.

Transparent electrode layer 208 is deposited on transparent composite layer 206 with conductive traces 209 being aligned in a first direction. For example, as shown in FIG. 3, conductive traces 209 are aligned with and/or parallel to the x-axis. Similarly, transparent electrode layer 204 is deposited on opposite sides of transparent composite layer 206 with its conductive traces 205 aligned perpendicular to conductive traces 209 of transparent electrode layer 208. For example, as shown in FIG. 2, conductive traces 205 may be aligned with and/or parallel to the y-axis.

By virtue of the perpendicular orientation of conductive traces 205 with respect to conductive traces 209, transparent electrode layers 204 and 208 present a plurality of possible conducting paths from conductive traces 205 of transparent electrode layer 204, through transparent composite layer 206, to conductive traces 209 of electrode layer 208 at each location where the conductive traces 205 and 209 overlap and intersect.

In this regard, transparent electrode layers 204 and 208 effectively produce an m×n array (or matrix) of potential conducting paths through transparent composite layer 206, where m is the number of rows of conductive traces 209 of electrode layer 208 and n is the number of columns of conductive traces 205 of transparent electrode layer 204. For example, in accordance with one embodiment, electrode layer 208 comprises 24 conductive traces 209 and transparent electrode layer 204 comprises 32 conductive traces 205, resulting in a 24×32 array of potential conducting paths.

In an exemplary embodiment, transparent composite layer 206 is realized as a resilient material with transparent conductive (or at least partially conductive) particles uniformly dispersed within the material. For example, transparent composite layer 206 may comprise a transparent elastomeric matrix, such as, polyester, phenoxy resin, polyimide, or silicone rubber, with transparent conductive or semiconductive particles such as indium tin oxide, zinc oxide, or tin oxide dispersed within the material. The thickness of transparent composite layer 206 may vary depending upon desired flexibility and other design considerations. In one embodiment, for example, transparent composite layer 206 has a thickness of between 3.0 and 20.0 microns.

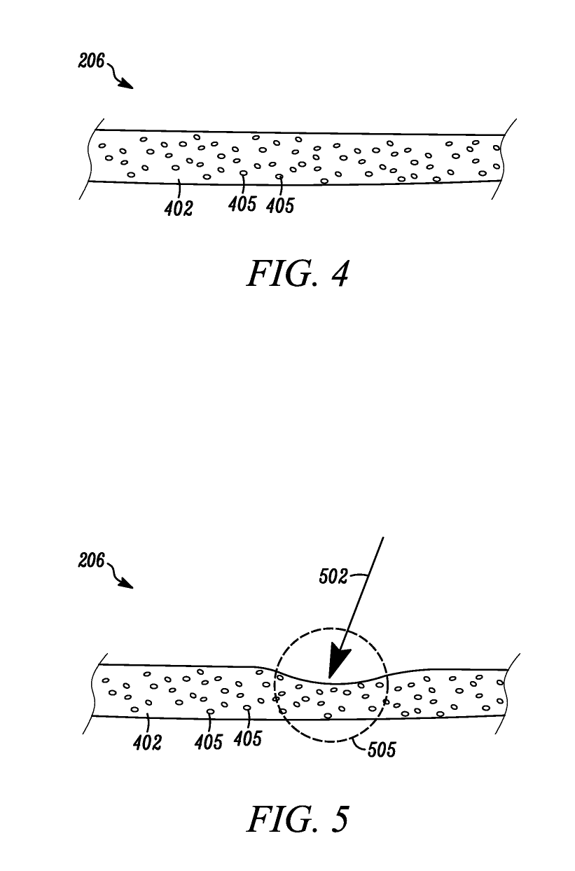

Referring to FIGS. 4 and 5 in conjunction with FIG. 3, in one embodiment, conductive composite 206 includes two constituent components: a polymer component 402, and a conducting particle component 405 embedded within or otherwise disposed within polymer component 402. When a force 502 is applied (directly or indirectly) to touch panel 100 (e.g., by a “downward” force in the positive z-direction), transparent composite layer 206 is compressed within a localized region 505, thereby reducing the average distance between adjacent conductive particles 405 dispersed within transparent composite layer 206 in region 505. In the interest of clarity, any intervening layers (such as protective layers 101 and 103, or electrode layers 204 and 208) are not illustrated in FIGS. 4 and 5.

The conductive paths formed by networks of adjacent particles thus increase in density (also known as percolation), thus increasing the conductance (or decreasing the resistance) of transparent composite layer 206 between overlapping conductive traces of transparent electrode layers 204 and 208 at the location(s) corresponding to the pressure applied to the touch panel 100 and/or transparent protective layer 101 (e.g., the impression location).

Thus, a greater force (or pressure) applied to touch panel 100 and/or transparent protective layer 101 in the positive z-direction results in greater compression of the transparent composite layer 206, and thereby, a greater increase in conductivity (or decrease in resistance) of transparent composite layer 206 at those locations. In this manner, transparent composite layer 206 acts as a variable resistance that is electrically in series with each conducting path between transparent electrode layers 204 and 208, wherein the amount of resistance for a respective conducting path is directly related to the magnitude of the pressure (or force) applied to the touch panel 100 at the location corresponding to the respective conducting path (i.e., the location overlying the conducting path along the z-axis).

The resistance is measured or otherwise determined for each conducting path of the plurality of conducting paths, that is, each location of the m×n array, to determine the pressure (or force) applied to the surface of the touch panel 100 and/or transparent protective layer 101 at the locations on touch panel 100 corresponding to the respective conducting path. As described in greater detail below, based on the resistance (or the change thereof) for each conducting path, a pressure (or force) metric for each conducting path is obtained, wherein the pressure (or force) metric is indicative of the magnitude of the pressure (or force) applied to touch panel 100.

Force-sensitive layer 102 is not limited to the particular embodiment described above, however. Other technologies, such as quantum tunneling composites, capacitive sensors, or other force-sensitive resistor technologies may be employed.

Referring again to FIG. 6 with continued reference to FIG. 3, in an exemplary embodiment touch panel 100 is integrated with display device 604 to provide a pressure-sensing (or force-sensing) touch screen 602. In an exemplary embodiment, touch panel 100 and display device 604 are separated by less than about 10 millimeters; however, in some embodiments, touch panel 100 is directly adjacent to (or in contact with) display device 604 (e.g., a negligible or substantially zero separation distance). Display device 604 is implemented as an electronic display configured to graphically display information under control of processing module 608. Depending on the embodiment, display device 604 may be implemented as a liquid crystal display (LCD), a cathode ray tube display (CRT), a light emitting diode (LED) display, an organic light emitting diode (OLED) display, a plasma display, a “digital ink” display, an electroluminescent display, a projection display, a field emission display (FED), or any another suitable electronic display.

Referring again to FIG. 6, with continued reference to FIG. 3, touch panel control circuitry 606 generally represents any combination of hardware, software, and/or firmware components configured to detect, measure or otherwise determine the resistance (or change thereof) for each conducting path of the plurality of conducting paths of the touch panel 100. That is, each location where conductive traces 205 and 209 overlap creates a conductive path through transparent composite layer 206. In this regard, touch panel control circuitry 606 is configured to scan each conducting path (e.g., each location of the m×n array), for example, by applying a reference voltage (or current) to a first conductive trace 215 of transparent electrode layer 204 and measuring the voltage (or current) at each conductive trace 209 of electrode layer 208 while maintaining the reference voltage applied to first conductive trace 215.

The measured voltage or current for each conductive trace 209 of second electrode layer 208 depends on the resistance of the transparent composite layer 206 between first conductive trace 215 of transparent electrode layer 204 and the respective conductive trace 209 of electrode layer 208. In this manner, touch panel 100 is pressure-sensitive (or force-sensitive) as its measured voltage (or current) directly relates to the pressure (or force) applied to touch panel 100.

After measuring the voltage or current for each conductive trace 209 of electrode layer 208 in response to applying the reference voltage to the first conductive trace 215, touch panel control circuitry 606 applies the reference voltage to a second conductive trace 217 of transparent electrode layer 204, and while maintaining the reference voltage applied to the second conductive trace 217, measures the voltage (or current) of each conductive trace 209 of electrode layer 208, and so on until the voltage (or current) has been measured for each possible conducting path. Touch panel control circuitry 606 then converts the measured voltages (or currents) to corresponding pressure metrics indicative of the magnitude of the pressure applied to the touch panel 100. Touch panel control circuitry 606 generates a corresponding pressure map (or pressure matrix) which maintains the association and/or correlation between pressure metrics and their corresponding location on the touch panel 100. In this regard, the pressure map may comprise an m×n array (or matrix) corresponding to the conducting paths of the touch panel 100, wherein each entry of the m×n array is a pressure metric based on the resistance (or change thereof) at the particular location of the touch panel 100. In this manner, touch panel control circuitry 606 and touch panel 100 are cooperatively configured to obtain pressure metrics that correspond to the pressure applied to touch panel 100. In an exemplary embodiment, the touch panel control circuitry 606 is configured to generate the pressure map at a rate of about 20 Hz to 200 Hz and provide the pressure map to the processing module 608, as described in greater detail below. Thus, each pressure map reflects the state of the pressure applied to the touch panel 100 at a particular instant in time.

Referring again to FIG. 6, processing module 608 generally represents one or more hardware, software, and/or firmware components configured to correlate an input gesture on touch screen 602 and/or touch panel 100 with content displayed on display device 604 and perform additional related tasks and/or functions. Depending on the embodiment, processing module 608 may be implemented as a general purpose processor, a content addressable memory, a digital signal processor, an application specific integrated circuit (ASIC), a field programmable gate array (FPGA), a programmable logic device, discrete gate or transistor logic, discrete hardware components, or any combination thereof. Processing module 608 may also be implemented as a combination of computing devices, e.g., a combination of a digital signal processor and a microprocessor, a plurality of microprocessors, one or more microprocessors in conjunction with a digital signal processor core, or any other such configuration.

In general, processing module 608 includes processing logic configured to carry out the functions, techniques, and processing tasks associated with the operation of display system 600. Furthermore, the steps of a method or algorithm described in connection with the embodiments disclosed herein may be embodied directly in hardware, in firmware, in a software module executed by the processing module 608, or any combination thereof. Any such software may be implemented as low level instructions (assembly code, machine code, etc.) or as higher-level interpreted or compiled software code (e.g., C, C++, Objective-C, Java, Python, etc.). Additional information regarding such touch screen algorithms may be found, for example, in co-pending U.S. patent application Ser. No. 12/549,008, filed Aug. 27, 2009.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A touch panel assembly comprising:
a flexible and substantially transparent composite layer having a resistivity that is a function of a pressure applied thereto; and
at least one transparent and flexible protective layer disposed adjacent the flexible and substantially transparent composite layer.

2. The touch panel assembly of claim 1, wherein the flexible and substantially transparent composite layer comprises a resilient material and a plurality of transparent conductive particles dispersed within the resilient material.

3. The touch panel assembly of claim 2, wherein the resilient material comprises a polymeric material.

4. The touch panel assembly of claim 3, wherein the polymeric material is selected from the group consisting of polyester, phenoxy resin, polyimide, and silicone rubber.

5. The touch panel assembly of claim 2, wherein the transparent conductive particles are selected from the group consisting of indium tin oxide, zinc oxide, and tin oxide.

6. The touch panel assembly of claim 1, wherein the at least one transparent and flexible protective layer is selected from the group consisting of polyethylene terephthalate, polymethylmethacrylate, and polycarbonate.

7. The touch panel assembly of claim 1, wherein the transparent and flexible composite layer has a thickness of about 3.0 to 20.0 um.

8. The touch panel assembly of claim 1, wherein the transparent and flexible composite layer includes a first set of parallel electrodes having a first orientation, and a second set of parallel electrodes having a second orientation substantially perpendicular to the first orientation.

9. A touch screen apparatus comprising:
a touch screen including:
a display device configured to display graphical content; and
a pressure-sensing touch panel aligned with respect to the display device such that at least a portion of the pressure-sensing touch panel overlaps at least a portion of the graphical content, wherein the pressure-sensing touch panel is flexible and substantially transparent; and
a processing module coupled to the touch screen;
wherein the processing module and the touch screen are cooperatively configured to modify the graphical content displayed on the display device in response to a force applied to the pressure-sensing touch panel.

10. The apparatus of claim 9, wherein the pressure-sensing touch panel comprises a transparent composite layer, and wherein the resistance of the transparent composite layer is a function of the pressure applied to the transparent pressure-sensing touch panel.

11. The apparatus of claim 10, further comprising:
a first flexible and transparent electrode layer disposed on the transparent composite layer; and
a second flexible and transparent electrode layer, the transparent composite layer being disposed on the second flexible and transparent electrode layer, wherein the processing module and the touch screen are cooperatively configured to determine the pressure applied to the transparent pressure-sensing touch panel based on the resistance of the transparent composite layer.

12. The apparatus of claim 11, wherein the transparent composite layer comprises a resilient material having transparent conductive particles dispersed within the resilient material.

13. The apparatus of claim 12, wherein the resilient material is selected from the group consisting of polyester, phenoxy resin, polyimide, and silicone rubber.

14. The apparatus of claim 12, wherein the transparent conductive particles are selected from the group consisting of indium tin oxide, zinc oxide, and tin oxide.

15. The apparatus claim 10, wherein the pressure-sensitive touch panel further includes at least one transparent protective layer adjacent the transparent composite layer and is selected from the group consisting of polyethylene terephthalate, polymethylmethacrylate, and polycarbonate.

16. The apparatus of claim 10, wherein display device has a substantially non-planar surface, and the pressure-sensitive touch panel conforms to the non-planar surface.

17. A method of manufacturing a flexible transparent pressure-sensitive touch panel, the method comprising:
forming a transparent polymer conductive composite layer comprising a plurality of conductive particles within a polymeric matrix such that the transparent polymer conductive composite is substantially flexible; and
forming at least one transparent protective layer on the transparent polymer conductive composite layer.

18. The method of claim 17, wherein the polymeric matrix comprises a phenoxy resin, and the plurality of conductive particles comprises indium tin oxide.

19. The method of claim 18, wherein the transparent polymer conductive composite layer is formed with a thickness between about 3.0 and 20. um.

20. The method of claim 17, wherein the at least one transparent protective layer is selected from the group consisting of polyethylene terephthalate, polymethylmethacrylate, and polycarbonate.
